(19) United States
(12) Patent Application Publication
(10) Pub. No.: US 2008/0306210 A1
(43) Pub. Date: Dec. 11, 2008

(54) Compositions For Producing Universal Pigment Preparations

(76) Inventors: Patrick Glockner, Haltern am See (DE); Evelyn Albrecht, Recklinghausen (DE); Andreas Wenning, Nottuln (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/158,800

(22) PCT Filed: Nov. 6, 2006
(86) PCT No.: PCT/EP2006/068113

§ 371 Date: Jun. 23, 2008

(30) Foreign Application Priority Data
Jan. 3, 2006 (DE) 102006000646.1

(51) Int. Cl. C08L 35/00; C08L 75/02; C08L 53/00; C08K 5/06; C08K 5/07; C08K 5/02; C08K 5/01; C08K 5/05; C08K 5/10; C08K 5/16; C08K 5/41

(52) U.S. Cl. 524/726; 524/843; 524/841; 524/876; 524/877; 524/742; 524/755; 524/765; 524/770; 524/773; 524/792; 524/769

(57) ABSTRACT

The invention relates to new compositions having good binder properties, wetting properties and dispersing properties not only for virtually foam-free aqueous pigment preparations but also for solvent-borne and solvent-free pigment preparations with very good heat stability and weathering stability.

The invention relates to new compositions having good binder properties, wetting properties and dispersing properties not only for virtually foam-free aqueous pigment preparations but also for solvent-borne and solvent-free pigment preparations with very good heat stability and weathering stability.

Dispersing fillers and pigments in liquid media is generally accomplished using dispersants, in order thus to reduce the mechanical shearing forces required for effective dispersion of the solids and at the same time to realize very high filling levels. The dispersants assist with the disruption of agglomerates, act as surface-active compounds to wet and/or clad the surface of the particles to be dispersed, and stabilize these particles against unwanted reagglomeration.

In the production of inks and paints, wetting agents and dispersants facilitate the incorporation of pigments and fillers, which, as important formulating ingredients, substantially determine the visual appearance and the physicochemical properties of coatings. In order to allow their optimum utilization, these fillers must on the one hand be dispersed uniformly in paints and inks and on the other hand, the state of dispersion, once attained, must be stabilized.

In many cases, the stabilizing component function is also accomplished by binder components, which are used in coating materials, particularly for the formation of a film. Binders of this kind are valuable components for coating materials on account additionally of their contribution to more rapid drying and to an increase in the hardness of the resultant films.

Important factors for application in universal pigment preparations include, firstly, universal compatibility with other binders—such as with the important long-oil alkyd resins, vegetable oils, hydrocarbon resins, acrylate resins, and polyamides, for example,—and, secondly, universal solubility in organic solvents, such as in the white spirits and pure aliphatics which are frequently employed on environmental and toxicological grounds, for example. Binders of this kind which can be used in pigment preparations with universal compatibility and solubility in organic solvents are described, for example in DE 44 04 809 and in EP 1486520.

Furthermore, however, for universal application, the systems must be stably transferable to water.

Dispersants used for universal pigment preparations include, in particular, alkylphenol ethoxylates or fatty alcohol alkoxylates, which contribute to the stearic stabilization of states of pigment dispersion that have been obtained, but which do not exhibit film-forming properties. The highly-performing alkylphenol ethoxylates have come under criticism on ecotoxicological grounds. In many countries their use in detergents and cleaning products is already prohibited. Similar bans are likely for the paints and inks industries. Fatty alcohol ethoxylates fail, in many cases, to attain the same good pigment-wetting properties as the alkylphenol ethoxylates, since they lack adsorptive groups. The unadsorbed portion of this product group, in particular, has the additional, unwanted effect of stabilizing the foam in aqueous pigment preparations.

Block-copolymeric polyalkylene oxides are toxicologically unobjectionable and highly adsorptive while having less of a foam-stabilizing effect, but are likewise not film-formers. They are described, for example in EP 1 078 946. However, these products are unable to achieve complete suppression of foam formation. Consequently, even here it is necessary to add actively defoaming substances to the aqueous pigment preparations. These substances, though, have other, adverse side-effects, such as unwanted surface defects. Many dispersing additives cannot be used on account of their adverse effect on the water resistance or light stability of coatings.

Compositions for producing universal pigment preparations are described in DE 10 2005 012 315.5 and their application in DE 10 2005 012 316.3. The ketone-aldehyde resins described therein are known. In pure form, ketone-aldehyde resins are used in coating materials as, for example, a film-forming addition component, in order to enhance certain properties such as initial drying rate, gloss, hardness or scratch resistance. On account of their relatively low molecular weight, typical ketone-aldehyde resins possess a low melt viscosity and solution viscosity.

As a result of irradiation, for example, the carbonyl groups of the ketone-aldehyde resins undergo conventional degradation reactions such as those, for example, of Norrish type I or II [Laue, Plagens, Namen und Schlagwort-Reaktionen, Teubner Studienbücher, Stuttgart, 1995]. It is therefore not possible to use ketone-aldehyde resins or ketone resins without modification for high-quality applications in the exterior segment, for example, where high resistance properties are called for, particularly in respect of weathering and heat. Moreover, the heat resistance of such resins is low.

These disadvantages can be remedied by hydrogenating the carbonyl groups. The conversion of the carbonyl groups into secondary alcohols by hydrogenation of ketone-aldehyde resins has been practiced for a long time (DE 826 974, DE 8 70 022, DE 32 41 735, JP 11012338, U.S. Pat. No. 6,222,009). The preparation of carbonyl-hydrogenated and ring-hydrogenated ketone-aldehyde resins based on ketones, containing aromatic groups, is likewise possible. Such resins are described in DE 33 34 631.

It was an object of the present invention, therefore, to find a composition which possesses good binder properties on the one hand and at the same time, on the other hand, good wetting properties and dispersing properties. The composition ought to be stable both to heat and to weathering.

The object on which the invention is based has surprisingly been achieved by the use of a combination of block-copolymeric, polyalkylene oxides containing styrene oxide with carbonyl-hydrogenated ketone-aldehyde resins and/or ring-hydrogenated phenol-aldehyde resins and/or urea-aldehyde resins.

Surprisingly, it has been found that the combination of block-copolymeric, polyalkylene oxides containing styrene oxide with carbonyl-hydrogenated ketone-aldehyde resins and/or ring-hydrogenated phenol-aldehyde resins and/or urea-aldehyde resins is outstandingly suitable as a film-forming dispersant for solvent-free, solvent-borne and aqueous universal pigment preparations.

A broad compatibility with binders, solubility in organic solvents used for universal pigment preparations, and miscibility and/or dispersibility in water have been found. Moreover, the formation of foam in aqueous pigment preparations is very efficiently suppressed. The properties of coating materials, such as initial drying and film hardness, are positively influenced when they contain the composition of the invention. Furthermore heat stabilities and weathering stabilities are high. Given knowledge of the prior art, it could not have been predicted that the combination of the individual components would lead to the composition having the stated sum of properties.

The invention provides compositions substantially containing
A) from 95% to 5% by weight of at least one block-copolymeric polyalkylene oxide containing styrene oxide, and
B) from 5% to 95% by weight of at least one carbonyl-hydrogenated ketone-aldehyde resin and/or ring-hydrogenated phenol-aldehyde resin and/or urea-aldehyde resin, and
C) from 0 to 80% by weight of at least one solvent,
   the sum of the amounts by weight of components A) to C) being 100% by weight.

Since block-copolymeric, polyalkylene oxides containing styrene oxide, carbonyl-hydrogenated ketone-aldehyde resins, ring-hydrogenated phenol-aldehyde resins and urea-aldehyde resins are all insoluble in water, it was completely surprising that a combination of the components is miscible and/or dispersible in water and allows them to be used in aqueous pigment preparations.

The block-copolymeric polyalkylene oxides containing styrene oxide that are used with preference in the invention, component A), are described, for example in EP 1 078 946. They possess the general formula (a):

R¹O(SO)ₐ(EO)_{b}(PO)_{c}(BO)_{d}R², (a)
where R¹ is a straight-chain or branched or cycloaliphatic radical having from 1 to 13 carbon atoms,
R²=hydrogen, an aryl radical, alkyl radical or carboxylic acid radical having in each case from 1 to 8 carbon atoms,
SO=styrene oxide,
EO=ethylene oxide,
PO=propylene oxide,
BO=butylene oxide and
a=1 to 10,
b=3 to 50,
c=0 to 3,
d=0 to 3,
a, c or d being other than 0, and b>=a+c+d.

Suitability as component A) in principle is possessed, however, by all block-copolymeric, polyalkylene oxides containing styrene oxide.

Suitable ketones for preparing the carbonyl-hydrogenated ketone-aldehyde resins (component B) include all ketones, in particular acetone, acetophenone, methyl ethyl ketone, 2-heptanone, 3-pentanone, methyl isobutyl ketone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones with one or more alkyl radicals, having in total 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

Generally speaking, however, it is possible to use all ketones said in the literature to be suitable for ketone resin syntheses, more generally all C—H-acidic ketones. Preference is given to carbonyl-hydrogenated ketone-aldehyde resins based on the ketones acetophenone, cyclohexanone, 4-tert-butylcyclohexanone, 3,3,5-trimethylcyclohexanone, methyl isobutyl ketone and heptanone alone or in a mixture.

Suitability as an aldehyde component of the carbonyl-hydrogenated ketone-aldehyde resins (component B) is possessed, in principle, by unbranched or branched aldehydes, such as formaldehyde, acetaldehyde, n-butyraldehyde and/or isobutyraldehyde, valeraldehyde and dodecanal. In general it is possible to use all of the aldehydes said in the literature to be suitable for ketone resin syntheses. Preference is given, however, to using formaldehyde, alone or in mixtures.

The necessary formaldehyde is employed typically in the form of an aqueous or alcoholic (e.g. methanol or butanol) solution with a strength of from approximately 20% to 40% by weight. Other use forms of formaldehyde as well, such as the use of para-formaldehyde or trioxane, are likewise possible. Aromatic aldehydes, such as benzaldehyde, may likewise be present in a mixture with formaldehyde.

Particularly preferred carbonyl-hydrogenated resins used as starting compounds for component B) are those formed from acetophenone, cyclohexanone, 4-tert-butylcyclohexanone, 3,3,5-trimethylcyclohexanone, methyl isobutyl ketone and heptanone alone or in a mixture and formaldehyde.

The resins formed from ketone and aldehyde are hydrogenated with hydrogen in the presence of a catalyst at pressures of up to 300 bar. In the course of this reaction the carbonyl group of the ketone-aldehyde resin is converted into a secondary hydroxyl group. Depending on reaction conditions, some of the hydroxyl groups may be eliminated, resulting in methylene groups. This is illustrated with the following scheme:

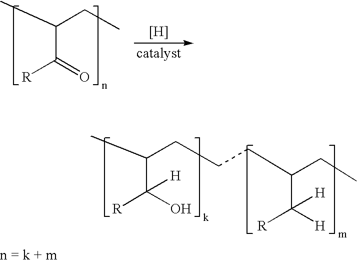

As component B) use is also made of ring-hydrogenated phenol-aldehyde resins of the novolak type, using, for example, the aldehydes formaldehyde, butyraldehyde or benzaldehyde, preferably formaldehyde. To a minor extent it is possible to use unhydrogenated novolaks, which then, however, possess lower lightfastnesses.

Particular suitability is possessed by ring-hydrogenated resins based on alkyl-substituted phenols. In general it is possible to use all of the phenols said in the literature to be suitable for phenolic resin syntheses.

Examples that may be mentioned of suitable phenols include phenol, 2- and 4-tert-butylphenol, 4-amylphenol, nonylphenol, 2- and 4-tert-octylphenol, dodecylphenol, cresol, xylenols and bisphenols. They can be used alone or in a mixture.

Very particular preference is given to using ring-hydrogenated, alkyl-substituted phenol-formaldehyde resins of the novolak type. Preferred phenolic resins are reaction products of formaldehyde and 2- and 4-tert-butylphenol, 4-amylphenol, nonylphenol, 2- and 4-tert-octylphenol and dodecylphenol.

The novolaks are hydrogenated with hydrogen in the presence of an appropriate catalyst. Through the choice of catalyst, the aromatic ring is converted into a cycloaliphatic ring. Through an appropriate choice of the parameters, the hydroxyl group is retained.

This is illustrated with the following scheme:

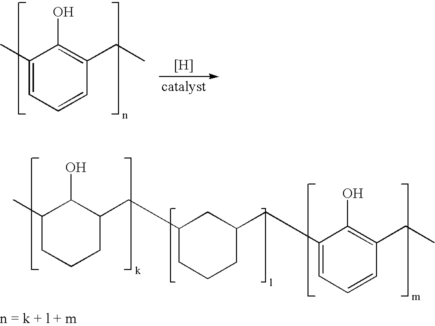

With the choice of the hydrogenating conditions, it is also possible to hydrogenate the hydroxyl groups, thereby forming cycloaliphatic rings. The ring-hydrogenated resins possess OH numbers of from 50 to 450 mg KOH/g, preferably from 100 to 350 mg KOH/g, more preferably from 150 to 300 mg KOH/g. The fraction of aromatic groups is below 50%, preferably below 30%, more preferably below 10% by weight.

The preparation of and the monomers for the urea-aldehyde resins (component B)) are described in EP 0 271 776:

As component B) use is made of urea-aldehyde resins using a urea of the general formula (i)

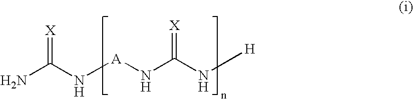

in which X is oxygen or sulfur, A is an alkylene radical and n is 0 to 3, with from 1.9 (n+1) to 2.2 (n+1) mol of an aldehyde of the general formula (ii)

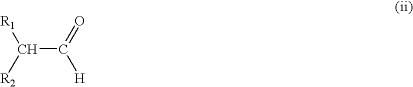

in which R¹ and R₂ are hydrocarbon radicals, (e.g., alkyl, aryl and/or alkylaryl radicals) having in each case up to 20 carbon atoms, and/or formaldehyde.

Suitable ureas of the general formula (i) with n=0 are, for example, urea and thiourea, with n=1, for example, methylenediurea, ethylenediurea, tetramethylenediurea and/or hexamethylenediurea and also mixtures thereof. Preference is given to urea.

Examples of suitable aldehydes of the general formula (ii) include isobutyraldehyde, 2-methylpentanal, 2-ethylhexanal and 2-phenylpropanal and also mixtures thereof. Preference is given to isobutyraldehyde.

Formaldehyde may be used in aqueous form, which in part or in whole may also include alcohols such as methanol or ethanol, for example, or else as para-formaldehyde and/or trioxane.

Generally speaking, all monomers described in the literature for the preparation of aldehyde-urea resins are suitable. Typical compositions are described, for example in DE 27 57 220, DE-A 27 57 176 and EP 0 271 776.

The mixing ratio of the inventively used block-copolymeric polyalkylene oxides containing styrene oxide to the ketone-aldehyde resins is from 95:5 to 5:95. If more than 50% by weight of component B) is used in this mixture then it is necessary to use an auxiliary solvent C), for reasons of viscosity.

Suitable components C) include water and all organic solvents. The organic solvents include for example alcohols, esters, ketones, ethers, glycol ethers, aromatic hydrocarbons, hydroaromatic hydrocarbons, halohydrocarbons, terpene hydrocarbons, aliphatic hydrocarbons, ester alcohols, dimethylformamide or dimethyl sulfoxide. It is also possible to use what are known as reactive diluents, which are typically used in radiation-curable paints and inks.

Solvents which can be used with preference as reactive diluents are acrylic acid and/or methacrylic acid, C₁-C₄₀ alkyl esters and/or cycloalkyl esters of methacrylic acid and/or acrylic acid, glycidyl methacrylate, glycidyl acrylate, 1,2-epoxybutyl acrylate, 1,2-epoxybutyl methacrylate, 2,3-epoxycyclopentyl acrylate, and 2,3-epoxycyclopentyl methacrylate and also the analogous amides, it also being possible for styrene and/or derivatives thereof to be present.

A further preferred class of radiation-reactive solvents as reactive diluents are di-, tri- and/or tetraacrylates and their methacrylate analogs, that result formally from the reaction products of acrylic acid and/or methacrylic acid and an alcohol component with elimination of water. As an alcohol component customary for this purpose, use is made for example of ethylene glycol, 1,2-, 1,3-propanediol, diethylene glycol, di- and tripropylene glycol, triethylene glycol, tetraethylene glycol, 1,2-, 1,4-butanediol, 1,3-butylethylpropanediol, 1,3-methylpropanediol, 1,5-pentanediol, 1,4-bis(hydroxymethyl)cyclohexane (cyclohexanedimethanol), glycerol, hexanediol, neopentyl glycol, trimethylolethane, trimethylolpropane, pentaerythritol, bisphenol A, B, C, F, norbomylene glycol, 1,4-benzyldimethanol, -ethanol, 2,4-dimethyl-2-ethylhexane-1,3-diol, 1,4- and 2,3-butylene glycol, di-B-hydroxyethylbutanediol, 1,5-pentanediol, 1,6-hexanediol, 1,8-octanediol, decanediol, dodecanediol, neopentyl glycol, cyclohexanediol, trimethylolpropane, 3(4),8(9)-bis(hydroxymethyl)-tricyclo[5.2.1.0^{2,6}]decane (Dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, polypropylene glycols, polybutylene glycols, xylylene glycols or neopentyl glycol hydroxypivalate, and also ethylene- or propylene-containing derivatives thereof, alone or in mixtures.

It is also possible to use ionic liquids as solvents. Ionic liquids for the purposes of the present invention are salts which have a melting point of not more than 100° C. An overview of ILs is given for example by Welton (Chem. Rev. 99 (1999), 2071) and Wasserscheid et al. (Angew. Chem. 112 (2000), 3926).

For pigment preparations which contain solvent, preference is given to organic solvents which are environmentally and toxicologically unobjectionable. For aqueous pigment preparations, organic solvents are preferred which are compatible or miscible, at least to a certain degree with water, and/or to ionic liquids. Suitability for radiation-curable pigment preparations is possessed by reactive solvents (reactive diluents) which are able to polymerize under induction by radiation.

For aqueous pigment preparations, however, the mixture of block-copolymeric polyalkylene oxides containing styrene oxide A) and carbonyl-hydrogenated ketone-aldehyde resins and/or ring-hydrogenated phenol-aldehyde resins and/or urea-aldehyde resins B) is preferably chosen so that there is no need to include an organic solvent as component C).

The invention also provides a process for preparing compositions substantially containing
A) from 95% to 5% by weight of at least one block-copolymeric polyalkylene oxide containing styrene oxide, and
B) from 5% to 95% by weight of at least one carbonyl-hydrogenated ketone-aldehyde resin and/or ring-hydrogenated phenol-aldehyde resin and/or urea-aldehyde resin, and
C) from 0 to 80% by weight of at least one solvent,
the sum of the amounts by weight of components A) to C) being 100% by weight,
   by mixing components A), B) and C) at a temperature of from 20 to 150° C. in a stirred tank.

The compositions of the invention are used in universal pigment preparations.

For their use, the compositions of the invention can either be mixed beforehand with the colorants that are to be dispersed or can be dissolved directly in the aqueous or solvent-containing dispersion medium, before or simultaneously with the addition of the colorants.

Colorants which can be used include, for example, organic or inorganic pigments and fillers and also carbon blacks and dyes.

Inorganic pigments and fillers are used such as, for example, Milori blue, titanium dioxide, iron oxides, metal pigments (e.g. spinel, bismuth vanadate, nickel titanium, chromium oxide), pigmentary carbon blacks, and carbonates, such as chalk, ground limestone, calcite, dolomite, and barium carbonate, sulfates, such as barytes, blanc fixe and calcium sulfates, silicates, such as talc, pyrophyllite, chlorite, mica, kaolin, slate flour, feldspars, precipitated Ca, Al, Ca/Al and Na/Al silicates, silicas, such as quartz, fused silica, cristobalite, kieselguhr, precipitated and/or pyrogenic silica, glass flour, oxides, such as magnesium oxides and hydroxides and aluminum oxides and hydroxides, fibrous fillers and also organic pigments such as isoindoline, azo, quinacridone, perylene and dioxazine, metal complex pigments such as phthalocyanines, anthraquinonoid pigments, polycyclic pigments, particularly those of the thioindigo, quinacridone, dioxazine, pyrrolo, naphthalinetetracarboxylic acid, perylene, isoamidolin(one), flavanthrone, pyranthrone or isoviolanthrone series. In addition it is possible to use metallic effect pigments such as aluminum, copper, copper/zinc and zinc pigments, oxidized bronzes, iron oxide-aluminum pigments, interference pigments and pearlescent pigments such as metal oxide-mica pigments, bismuth oxychloride, basic lead carbonate, pearl essence or micronized titanium dioxide, graphite in leaflet form, iron oxide in leaflet form, multilayer effect pigments comprising PVD films or produced by the CVD (chemical vapor deposition) method, and also liquid-crystal (polymer) pigments. Dyes are also employed. Dyes which are soluble in the binder solutions and that can be employed include all natural or synthetic organic dyes. The colorations obtained using them possess optimum transparency but not opacity. In contrast to pigments, their color strength can be utilized to the full.

A compilation of pigments, dyes, and fillers used is given in Römpp Lexikon Lacke und Druckfarben, Dr. Ulrich Zorll (ed.), Georg Thieme Verlag, Stuttgart, 1998 or in Pigment- und Füllstofftabellen, edited by Olaf Lückert, Vincentz Verlag, Hanover 2002.

Carbon blacks which can be used include gas blacks, lamp blacks or furnace blacks. These blacks may have been additionally reoxidized and/or beaded.

The compositions of the invention are notable for very good adsorptivity to pigments, excellent foam destruction, and a low viscosity. Moreover, the gloss, drying rate, water resistance, chemical resistance and hardness of coatings are positively influenced. The heat stability and weathering stability are very good.

The examples which follow are intended to illustrate the invention but not to restrict the scope of its application:

### EXAMPLES

### 1) Preparation of a Styrene Oxide-Containing Polyalkylene Oxide (Component A))

336.4 g (2.34 mol) of trimethylcyclohexanol and 16.3 g (0.23 mol) of potassium methoxide were charged to a reactor. After careful flushing with pure nitrogen, the initial charge was heated to 110° C., and 308.2 g (2.554 mol) of styrene oxide were added over the course of an hour. After a further two hours, the addition of the styrene oxide was at an end, as evidenced by a residual styrene oxide content of <0.1% by weight according to gas chromatogram. Subsequently 339.2 g (7.71 mol) of ethylene oxide were metered into the reactor at a rate such that the internal temperature did not exceed 120° C. and the pressure did not exceed 6 bar. Following complete introduction of the ethylene oxide, the temperature was held at 115° C., until a constant manometer pressure indicated the end of the subsequent reaction. Lastly, at 80 to 90° C., the unreacted residual monomers were removed under reduced pressure. The product obtained was neutralized with the aid of phosphoric acid, followed by removal of the water by distillation and of the resultant potassium phosphate by filtration together with a filter aid. The molecular weight from the determination of the hydroxyl number, with an assumed functionality of 1, was M =467 g/mol.

### 2) Preparation of a Carbonyl-Hydrogenated Ketone-Aldehyde Resin (Component B))

1200 g of acetophenone, 220 g of methanol, 0.3 g of benzyltributylammonium chloride and 360 g of a 30% strength aqueous formaldehyde solution are introduced as an initial charge and homogenized with stirring. Then 32 g of 25% strength aqueous sodium hydroxide solution are added with stirring. This is followed at 80 to 85° C. by the addition with stirring of 655 g of 30% strength aqueous formaldehyde solution over 90 minutes. After 5 hours of stirring at reflux temperature the stirrer is switched off and the aqueous phase is separated from the resin phase. The crude product is washed with water, to which acetic acid has been added, until a melt sample of the resin appears clear. At that point the resin is dried by distillation.

This gives 1270 g of a pale yellowish resin. The resin is clear and brittle and possesses a melting point of 72° C. It is soluble in, for example, acetates such as butyl acetate and ethyl acetate, and in aromatics such as toluene and xylene. It is insoluble in ethanol.

400 g of the resin thus prepared are dissolved in 650 g of tetrahydrofuran (water content approximately 7%). It is then hydrogenated at 260 bar and 160° C. in an autoclave (from Parr) with a catalyst basket filled with 100 ml of a commercially customary Ru catalyst (3% Ru on alumina). After 20 hours the reaction mixture is discharged from the reactor via a filter. Properties: hydroxyl number: 315 mg KOH/g; melting point 116° C.; Gardner color number (50% in ethyl acetate): 0.2.

The hydrogenated resin is soluble in ethanol, dichloromethane, ethyl acetate, butyl acetate, isopropanol, acetone and diethyl ether. It is insoluble in apolar solvents such as n-hexane or white spirit.

### 3) Production of the Inventive Composition

600 g of the styrene oxide-containing polyalkylene oxide from Example 1) and 400 g of the carbonyl-hydrogenated ketone-aldehyde resin from Example 2) were mixed with one another and homogenized at 100° C. with stirring. The product was clear and of high viscosity and was soluble in water, ethanol, ethyl acetate, butyl acetate and xylene.

To investigate the activity of the composition of the invention as a dispersing additive with binder properties, and of the comparative compounds, the following procedure was adopted:

### 4) Production of Pigment Preparations

For this purpose the inventive composition from Example 3) was mixed with water and/or organic solvent, after which the pigments were added. Dispersion took place, following the addition of 2 mm glass beads, at 35° C. and 3000 rpm in a Dispermat for 30 minutes. The aqueous pigment preparations were adjusted to a pH of approximately 9 using a 1:1% by weight mixture of dimethylaminoethanol and water.

### 4A) Formulation of an Aqueous Black Pigment Preparation (Inventive)

63 g water

8 g inventive composition from Example 3)

20 g Spezialschwarz 4 carbon black (Degussa AG)

This black pigment preparation was readily stirrable and foam-free.

### 4B) Formulation of an Aqueous Black Pigment Preparation (Comparative)

71 g water

8 g noninventive compound from Example 1)

20 g Spezialschwarz 4 carbon black (Degussa AG)

This black pigment preparation was highly viscous and foamed severely.

### 4C) Formulation of a Solvent-Borne Black Pigment Preparation (Inventive)

75 g butyl glycol

25 g inventive composition from Example 3)

20 g Spezialschwarz 4 carbon black (Degussa AG)

This black pigment preparation was of low viscosity.

### 4D) Formulation of an Aqueous Blue Pigment Preparation (Inventive)

80.0 g water

20.0 g inventive composition from Example 3)

48.0 g Heliogenblau L 6975F blue pigment (BASF AG)

This blue pigment preparation was of low viscosity, readily stirrable, and foam-free. Its stability was unchanged even after storage at 50° C. for more than one week.

### 4E) Formulation of an Aqueous Blue Pigment Preparation (Comparative)

80.0 g water

20.0 g noninventive compound from Example 1)

48.0 g Heliogenblau L 6975F blue pigment (BASF AG)

This blue pigment preparation was highly viscous and foamed severely.

5) Preparation of Coating Materials from the Pigment Preparations

To prepare coating materials the letdown compounds were introduced initially and then the pigment preparations were added in portions.

### 5A) Preparation of Solvent-Free Black Coating Materials

The inventive (Example 4A) and noninventive (Example 4B) pigment preparations were let down with an aqueous polyurethane dispersion.

| | inventive | comparative |
|---|---|---|
| Black pigment | 8.4 g from | 8.4 g from |
| preparation | Example 4A) | Example 4B) |
| Alberdingk U 800 | 63.0 g | 63.0 g |
| (Alberdingk Boley GmbH) | | |
| Drying: 1 h at 60° C., drawdown on glass plate | | |
| with 100 μm drawing frame | | |
| Gloss 20° | 75 | 74 |
| Gloss 60° | 88 | 84 |
| Haze gloss | 17 | 22 |
| Pendulum hardness | 94 | 87 |

### 5B) Preparation of Solvent-Borne and Low-Solvent Black Coating Materials

The inventive solvent-borne black pigment preparation (Example 4C) was let down as both a solvent-borne and an aqueous system.

| Black pigment | 6.8 g from | 7.0 g from |
|---|---|---|
| preparation | Example 4C) | Example 4C) |
| Degalan 706 (Röhm GmbH) | 50.0 g | 63.0 g |
| Dynapol HW 112-56 | — | 55.5 g |
| (Degussa AG) | | |
| Cymel 325 (Cytec) | — | 3.7 g |
| Demineralized water | — | 10.0 g |
| Tego 7447, 10% in water | — | 0.8 g |
| (Tego Chemie Service | | |
| GmbH) | | |
| Drawdown on glass plate with | Drying: 24 h at | Drying: 20 min at |
| 100 μm drawing frame | 25° C. | 140° C. |
| Gloss 20° | 76 | 95 |
| Gloss 60° | 89 | 99 |
| Haze gloss | 19-28 | 67-74 |
| Pendulum hardness | 148 | 186 |

### 6) Production of Tinted Paints

To produce tinted coating materials the blue-pigmented pigment preparations of Examples 4D) and 4E) were mixed with a white paint.

The white paint consisted of 70.69 g Alberdingk U 800 (Alberdingk Boley GmbH), 28.24 g Kronos 2310 (Kronos Titan GmbH) and 0.07 g Aerosil 200 (Degussa AG).

| | inventive | comparative |
|---|---|---|
| White paint | 99.0 g | 99.0 g |
| Blue pigment | 3.7 g from Example 4D) | 3.7 g from Example 4E) |
| preparation | | |
| Demineralized | 6.5 g | 6.5 g |
| water | | |

The binder/white pigment ratio was 1:1, the blue pigment/white paint ratio 1:100.

The tinting paints, drawn down with a 100 μm drawing frame, were dried for 2 minutes and then subjected to a rub-out test. In addition the relative color strength was ascertained.

| | Color strength F | ΔE after rub-out |
|---|---|---|
| Inventive | 100 | 0.29 |
| Comparative | 94 | 0.45 |

The tinting paint based on the inventive composition also dried much more quickly than the comparative tinting paint.

The films were stored in an oven at 60° C. for 14 days. No yellowing was observed.

In addition the coatings were stored for 1000 h in a Weather-Ometer.

| | Relative loss of gloss¹⁾ | Relative b* value²⁾ |
|---|---|---|
| Inventive | 0.75 | 1.4 |
| Comparative | 0.70 | 1.4 |

¹⁾Gloss after/gloss before weathering
²⁾b* after/b* before weathering

The compositions of the invention possess good heat stability and weathering stability.

With the compositions of the invention it is possible to produce solvent-borne, low-solvent and solvent-free pigment preparations and coating materials. Unlike the comparative examples, the aqueous pigment preparations are of low viscosity and virtually foam-free. Moreover, positive influence was exerted on the development of color strength and on the flocculation stability of pigment preparations, and also on the initial drying of coatings.

1. A composition comprising
A) from 95% to 5% by weight of at least one block-copolymeric polyalkylene oxide containing styrene oxide,
B) from 5% to 95% by weight of at least one carbonyl-hydrogenated ketone-aldehyde resin and/or ring-hydrogenated phenol-aldehyde resin and/or urea-aldehyde resin, and
C) from 0 to 80% by weight of at least one solvent,
the sum of the amounts by weight of components A) to C) being 100% by weight.

2. The composition according to claim 1, characterized in that
the block-copolymeric polyalkylene oxide A) containing styrene oxide has a formula according to general formula I:
R¹O(SO)ₐ(EO)_{b}(PO)_{c}(BO)_{d}R² (I)
where R¹ is a straight-chain or branched or cycloaliphatic radical having from 1 to 13 carbon atoms,
R²=hydrogen, an aryl radical, alkyl radical or carboxylic acid radical having in each case from 1 to 8 carbon atoms,
SO=styrene oxide,
EO=ethylene oxide,
PO=propylene oxide,
BO=butylene oxide and
a=1 to 10,
b=3 to 50,
c=0 to 3,
d=0 to 3,
a, c or d is other than 0, and b>=a+c+d.

3. The composition according to claim 1,
characterized in that a
C—H-acidic ketone is used to prepare the carbonyl-hydrogenated ketone-aldehyde resin B).

4. The composition according to claim 1,
characterized in that a
ketone selected from acetone, acetophenone, methyl ethyl ketone, 2-heptanone, 3-pentanone, methyl isobutyl ketone, cyclopentanone, cyclododecanone, mixtures of 2,2,4- and 2,4,4-trimethylcyclopentanone, cycloheptanone, cyclooctanone and cyclohexanone is used as a starting compound, alone or in a mixture, for preparing the carbonyl-hydrogenated ketone-aldehyde resin B).

5. The composition according to claim 1,
characterized in that an
alkyl-substituted cyclohexanone with one or more alkyl radicals having a total of from 1 to 8 carbon atoms is used, individually or in a mixture, for preparing the carbonyl-hydrogenated ketone-aldehyde resin B).

6. The composition according to claim 1,
characterized in that
tert-butylcyclohexanone, 2-methylcyclohexanone and 3,3,5-trimethylcyclohexanone are used for preparing the carbonyl-hydrogenated ketone-aldehyde resin B).

7. The composition according to claim 1,
characterized in that
cyclohexanone, 4-tert-butylcyclohexanone, 3,3,5-trimethylcyclohexanone, methyl isobutyl ketone or heptanone, alone or in a mixture, is used for preparing the carbonyl-hydrogenated ketone-aldehyde resin B).

8. The composition according to claim 1,
characterized in that
formaldehyde, acetaldehyde, n-butyraldehyde and/or isobutyraldehyde, valeraldehyde or dodecanal is used, alone or in a mixture, as the aldehyde component for preparing the carbonyl-hydrogenated ketone-aldehyde resin B).

9. The composition according to claim 1,
characterized in that
formaldehyde and/or para-formaldehyde and/or trioxane are used for preparing the carbonyl-hydrogenated ketone-aldehyde resin B).

10. The composition according to claim 1,
characterized in that a
hydrogenation product of the resin formed from acetophenone, cyclohexanone, 4-tert-butylcyclohexanone, 3,3,5-trimethylcyclohexanone, methyl isobutyl ketone, heptanone alone or in a mixture, and formaldehyde is used as carbonyl-hydrogenated ketone-aldehyde resin B).

11. The composition according to claim 1,
characterized in that
formaldehyde, butyraldehyde and/or benzaldehyde are used as the aldehyde for preparing the ring-hydrogenated phenol-aldehyde resin B).

12. The composition according to claim 1,
characterized in that an
alkyl-substituted phenol is used for preparing the ring-hydrogenated phenol-aldehyde resin B).

13. The composition according to claim 1,
characterized in that
4-tert-butylphenol, 4-amylphenol, nonylphenol, tert-octylphenol, dodecylphenol, kresol, a xylenol or a bisphenol, alone or in a mixture, is used for preparing the ring-hydrogenated phenol-aldehyde resin B).

14. The composition according to claim 1,
characterized in that a
urea-aldehyde resin prepared using a urea of the general formula (i) 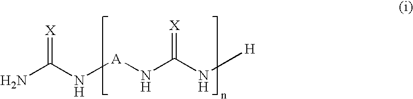
in which X is oxygen or sulfur, A is an alkylene radical and n is 0 to 3, with from 1.9 (n+1) to 2.2 (n+1) mol of an aldehyde of the general formula (ii) 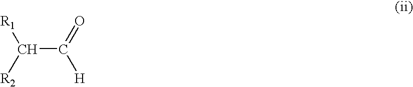
in which R₁ and R₂ are hydrocarbon radicals having in each case up to 20 carbon atoms, and/or
formaldehyde, is used as component B).

15. The composition according to claim 1,
characterized in that a
urea-aldehyde resin prepared using urea and thiourea, methylenediurea, ethylenediurea, tetramethylenediurea and/or hexamethylenediurea or a mixture thereof is used as component B).

16. The composition according to claim 1,
characterized in that a
urea-aldehyde resin prepared using isobutyraldehyde, formaldehyde, 2-methylpentanal, 2-ethylhexanal or 2-phenylpropanal or a mixture thereof is used as component B).

17. The composition according to claim 1,
characterized in that, a
urea-aldehyde resin prepared using urea, isobutyraldehyde and formaldehyde is used as component B).

18. The composition according to claim 1,
characterized in that
the mixing ratio of components A) and B) is from 95:5 to 5:95.

19. The composition according to claim 1,
characterized in that
water is present as solvent C).

20. The composition according to claim 1,
characterized in that
an organic solvent is present as solvent C).

21. The composition according to claim 1,
characterized in that
at least one alcohol, ester, ketone, ether, glycol ether, aromatic hydrocarbon, hydroaromatic hydrocarbon, halohydrocarbon, terpene hydrocarbon, aliphatic hydrocarbon, ester alcohol, dimethylformamide, dimethyl sulfoxide or radiation-curable reactive diluent or ionic liquid, alone or in a mixture, is present as solvent C).

22. A process for preparing a composition comprising
A) from 95% to 5% by weight of at least one block-copolymeric polyalkylene oxide containing styrene oxide,
B) from 5% to 95% by weight of at least one carbonyl-hydrogenated ketone-aldehyde resin and/or ring-hydrogenated phenol-aldehyde resin and/or urea-aldehyde resin, and
C) from 0 to 80% by weight of at least one solvent,
the sum of the amounts by weight of components A) to C) being 100% by weight,
said process comprising mixing components A), B) and C) at a temperature of from 20 to 150° C. in a stirred tank.
